(19) United States
(12) Patent Application Publication
(10) Pub. No.: US 2013/0074798 A1
(43) Pub. Date: Mar. 28, 2013

(54) TRAY FOR OIL PAN

(71) Applicant: Bradley J. Shaffer, Romney, IN (US)

(72) Inventor: Bradley J. Shaffer, Romney, IN (US)

(73) Assignee: Caterpillar Inc., Peoria, IL (US)

(21) Appl. No.: 13/246,908

(22) Filed: Sep. 28, 2011

(51) Int. Cl. F01M 11/00; B01D 19/00

(52) U.S. Cl. 123/196 R; 96/220; 96/219; 95/241

(57) ABSTRACT

A tray for de-aeration of oil contained in an oil pan including an inner surface, an outer surface, and a side surface. The inner surface is adapted to face a bottom surface of the oil pan. The outer surface is adapted to face an oil-gas interface of the oil contained in the oil pan. The side surface extends from the inner surface. Moreover, the side surface encloses a submerged surface to collect aeration bubbles present in the oil.

### TECHNICAL FIELD

The present disclosure relates to a lubrication system for an engine, and more particularly relates to an oil pan used in the lubrication system.

### BACKGROUND

Oil contained in an oil pan of an engine needs to be free of any air. U.S. Pat. No. 3,727,725 discloses a suction funnel attached to an oil pump. The suction funnel is supported at the bottom of the oil pan using an elastic hollow spacer. The hollow spacer is provided with one or several openings at its lower end for air-free aspiration of the oil using the oil pump.

### SUMMARY OF THE DISCLOSURE

In one aspect, the present disclosure provides a tray for de-aeration of oil contained in an oil pan. The tray includes an inner surface, an outer surface, and a side surface. The inner surface faces a bottom surface of the oil pan. Further, the outer surface faces an oil-gas interface of the oil contained in the oil pan. The side surface extends from the inner surface. The side surface encloses a submerged surface to collect aeration bubbles present in the oil.

In another aspect, the present disclosure provides a method for de-aeration of oil contained in an oil pan. The method includes providing a submerged surface for collecting aeration bubbles present in the oil. Further, the collected aeration bubbles merge to form larger aeration bubbles on the submerged surface. The method includes moving the larger aeration bubbles towards an oil-gaseous interface and subsequently, bursting the larger aeration bubbles at the oil-gaseous interface.

Other features and aspects of this disclosure will be apparent from the following description and the accompanying drawings.

### BRIEF DESCRIPTION OF THE DRAWINGS

FIG. 1 is a schematic of an engine having an oil pan.

FIG. 2 is a schematic of a tray for de-aeration of oil contained in the oil pan;

FIG. 3 is a schematic of the tray with a screen in the oil pan;

FIG. 4 is a schematic of two trays with the screen in the oil pan;

FIG. 5 is a schematic of the trays in the oil pan;

FIG. 6 is another schematic of the trays in the oil pan; and

FIG. 7 is a process for de-aeration of the oil contained in the oil pan.

### DETAILED DESCRIPTION

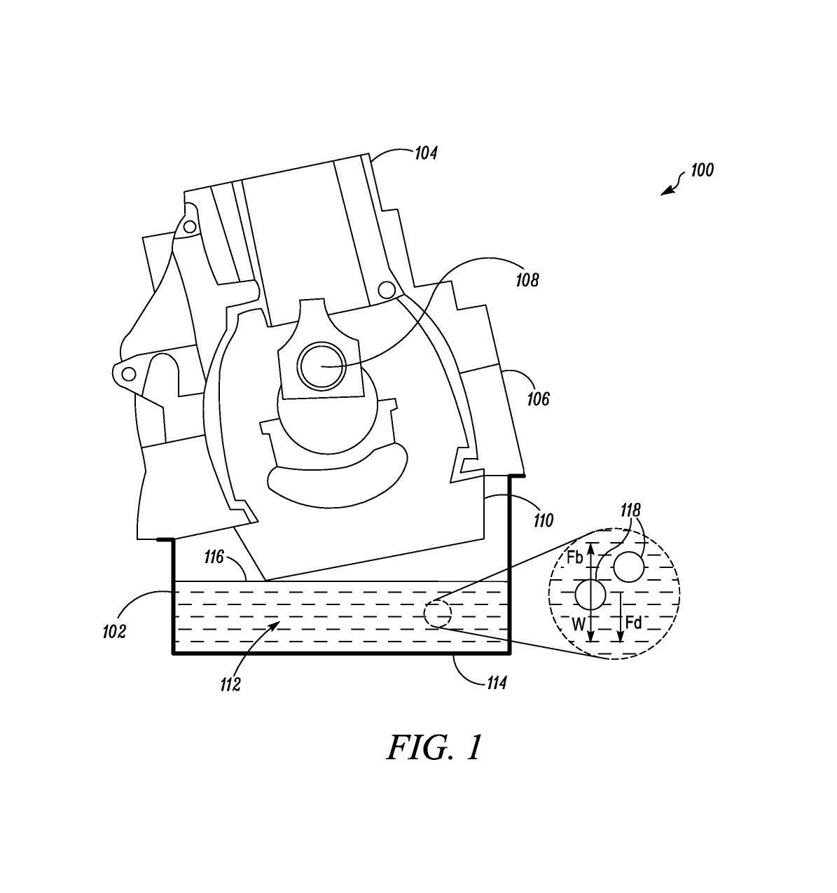

FIG. 1 illustrates a cross-sectional view of an engine 100 having a lubrication system including an oil pan 102. The engine 100 may include a diesel engine, a gasoline engine, a natural gas engine, an internal combustion engine, or any other machine device having an aerated oil reservoir volume, such as the oil pan 102. Moreover, the engine 100 may be used to power any machine or other engine powered application such as, trucks, earth moving equipments, marine propulsion systems, compressors, pumps, and the like.

In an embodiment, the engine 100 may include a cylinder block 104. The size of the engine 100, the number of cylinders and arrangement of the cylinder block 104, may vary without deviating from the scope of the disclosure. A ladder frame 106 may be attached to a lower surface of the cylinder block 104. Further, a crank-shaft 108 may be rotatably supported between the ladder frame 106 and the cylinder block 104.

The oil pan 102 may contain a fluid, such as lubricating oil 112 (hereinafter referred as oil) used for lubrication and/or for cooling of the engine 100. The oil pan 102 has a bottom surface 114 and an oil-gaseous interface 116 formed by the oil 112 in the oil pan 102. In an embodiment, the engine may include a device to agitate or stir the oil 112 in the oil pan 102. As depicted in FIG. 1, the oil pan 102 may be attached to a lower surface of the ladder frame 106. A person of ordinary skill in the art will understand that based on the size and application of the engine 100, the size and placement of the oil pan 102 may vary.

Further, a baffle plate 110 may be secured to a bottom surface of the ladder frame 106 with the help of fasting means, such as bolts. The baffle plate 110 may be in contact with the oil-gaseous interface 116 of the oil 112. The baffle plate 110 may be positioned substantially inclined at an angle to the oil-gaseous interface 116 of the oil 112. It may be understood to a person skilled in art that the arrangement depicted in FIG. 1 does not limit the scope of the disclosure.

The oil 112 may contain a plurality of aeration bubbles 118. The aeration bubbles 118 may contain air that is trapped in the oil 112. The amount of the aeration bubbles 118 present in the oil 112 may be proportional to the oil droplets falling from the crank-shaft 108, which may impinge the oil-gaseous interface 116. Further, operating conditions of the engine 100 may also contribute to the formation of the aeration bubbles 118 in the oil 112 in a variety of ways, such as, during changing the oil 112, pumping of the oil 112, or the like. The size of the aeration bubbles 118 may vary depending upon the amount of the trapped air.

The aeration bubbles 118 may rise to the oil-gaseous interface 116 under a buyout force F_{b}. Opposed to the buoyant force F_{b}, the weight W of the aeration bubble 118 and a drag force F_{d} may act in downward direction. As illustrated in FIG. 1, at equilibrium, the buoyant force F_{b} is equal to the weight W of the aeration bubbles 118 and the drag force F_{d}. Thus, the aeration bubbles 118 move towards the oil-gaseous interface 116 with a terminal velocity. At the oil-gaseous interface 116 the aeration bubbles 118 may get thinner under a gravitational force, which acts opposite to surface tension and viscosity of the oil 112, and burst to release the trapped air.

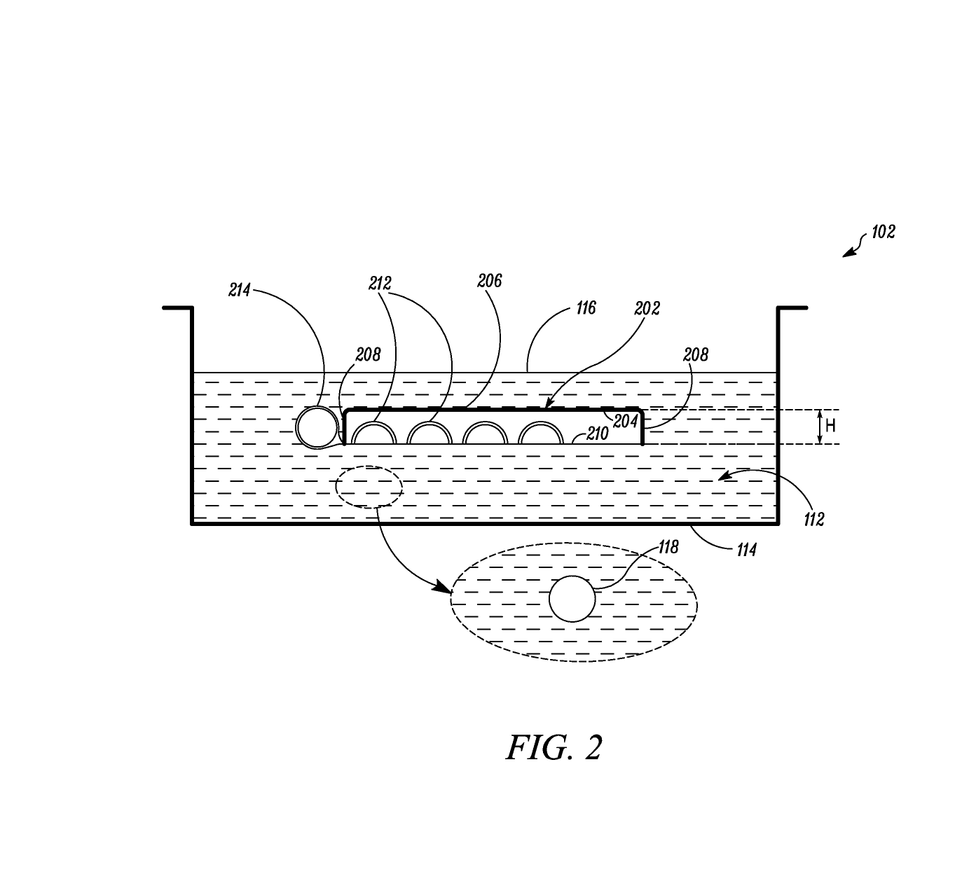

As illustrated in FIGS. 2-6, the oil pan 102 may include a tray 202, for de-aeration of the oil 112 in the oil pan 102. In an embodiment, the tray 202 may be composed of sheet metal. However, in various other embodiments, the tray 202 may be composed of plastic, composites, etc. As illustrated in FIG. 2, the tray 202 may include an inner surface 204. The inner surface 204 of the tray 202 may face the bottom surface 114 of the oil pan 102. Further, the tray 202 may have an outer surface 206. The outer surface 206 may face the oil-gaseous interface 116. The tray 202 may also include a side surface 208 extending from the inner surface 204. In an embodiment, the tray 202 may have a circular shape. However, in other embodiments, the tray 202 may have a polygonal shape having a plurality of the side surfaces 208. The side surface 208 may suspend the tray 202 in the oil 112, such that the tray 202 may be loosely or lightly fixed in to the oil pan 102 and prevent the tray 202 from floating upwards. In an embodiment, the tray 202 may be suspended substantially parallel to the bottom surface 114 of the oil pan 102.

Further, in an embodiment, the inner surface 204 of the tray 202 may provide a surface to catch the aeration bubbles 118 to merge and form large aeration bubbles 212. The merging of the aeration bubbles 118 may be aided by vibrations of the engine 100. Moreover, the merging of the aeration bubbles 118 may be accelerated at the inner surface 204 by any of several means known in the art such as by surface texture or surface treatment at the inner surface 204 with a surfactant. In an embodiment, the side surface 208 encloses a submerged surface 210. The submerged surface configured to collect the aeration bubbles 118. As illustrated in FIG. 2, the submerged surface 210 may act as an additional oil-gaseous interface to collect the aeration bubbles 118, which then merge to form the larger aeration bubbles 212.

The larger aeration bubbles 212 may continue to collect and grow in size by the merging of more of the aeration bubbles 118. The submerged surface 210 may reach to a height H of the tray 202 when the trapped air, contained in the aeration bubbles 118, may fill between the submerged surface 210 and the inner surface 204 of the tray 102. The trapped air may be released out of the tray 202 and move towards the oil-gaseous interface 116 in the form of a larger aeration bubble 214. It may be evident to one of ordinary skill in the art that the larger aeration bubbles 214 may have a larger buoyant force F_{b} acting on them as compared to the aeration bubbles 118 which are smaller; making it easier for the larger aeration bubbles 214 to reach oil-gaseous interface 116 and burst.

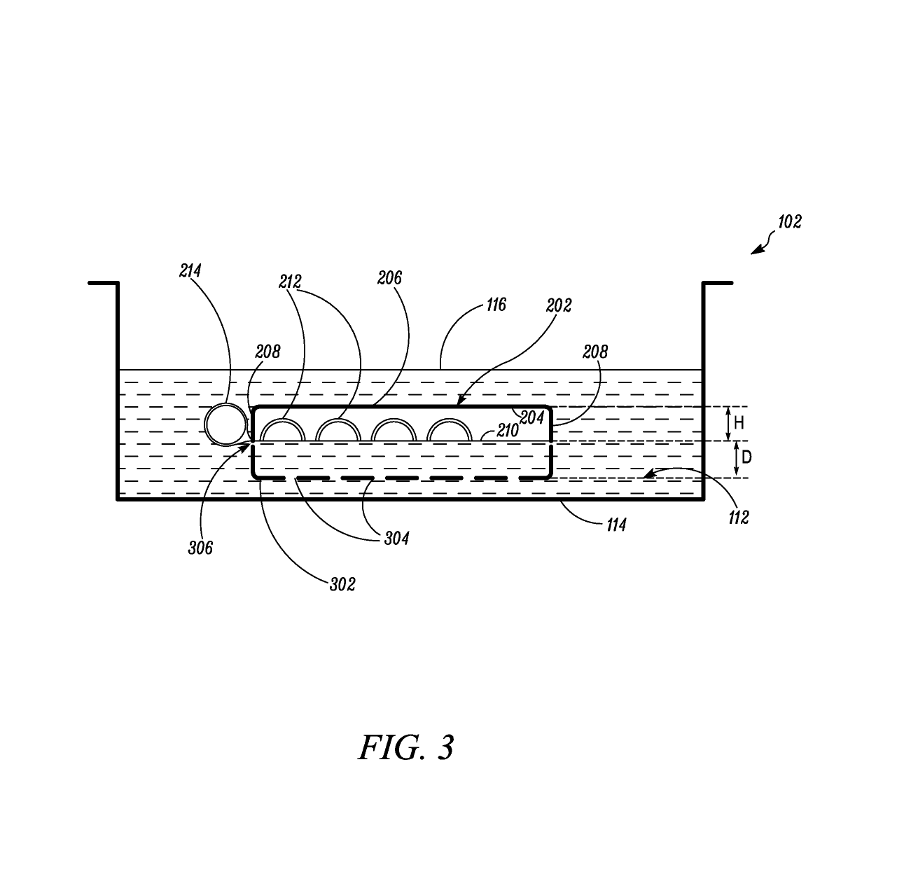

FIG. 3 illustrates the tray 202 with a screen 302, according to another embodiment of the present disclosure. As illustrated in FIG. 3, the screen 302 may be disposed adjacent to the tray 202, such that the screen 302 may be in contact with the side surface 208 of the tray 202. In an embodiment, the screen 302 may be also composed of sheet metal and joined with the tray 202 using welding, brazing, riveting or any other practical means.

The screen 302 may assist in isolating the oil 112 within a loose confine created between the tray 202 and the screen 302. The screen 302 may also be configured to minimize turbulences or currents circulating within the oil pan 102 so as to avoid the larger aeration bubbles 212 from being swept out of contact with the inner surface 204 and the submerged surface 210. The oil 112 loosely confined between the tray 202 and the screen 302 may provide a residence time to the aeration bubbles 118 to collide while rising due to the buoyant force F_{b} to merge to form the larger aeration bubbles 212 on the submerged surface 210. In various other embodiments of the present disclosure, two or more trays 202 may be provided within the confined space to provide more submerged surfaces 210 to merge the aeration bubbles 118.

In an embodiment, the screen 302 may be a protective mesh having a plurality of apertures 304. A diameter of the apertures 304 may be greater than or equal to a diameter of the aeration bubbles 118. A person of ordinary skill in the art will appreciate that a porosity level of the screen 302 may vary based on the size the aeration bubbles 118. The aeration bubbles 118 may collect on the submerged surface 210 on passing through the apertures 304 of the screen 302.

In an embodiment, a port 306 may be provided between the screen 302 and the side surface 208 of the tray 202. Moreover, the port 306 may be located at the height H. When the trapped air in the tray 202 exceeds the height H, the port 306 may release the trapped air in the form of the larger aeration bubbles 214. The larger aeration bubbles 214 released from the port 306 may then move towards the oil-gaseous interface 116 and burst to release the trapped air.

The height H of the port 306 may be provided such that the trapped air from the aeration bubbles 118 may collect within the height H and the remaining space till the screen 302 may be filled with the oil 112. A person of ordinary skill in the art will appreciate a depth D of the oil 112 within the tray 202 may be optimized to co-ordinate the number of layers of trays 202 that may be stacked within the volume of the oil pan 102. Further, the depth D may also be selected so as to most efficiently de-aerate the oil 112 based on the mean size of the aeration bubbles 118.

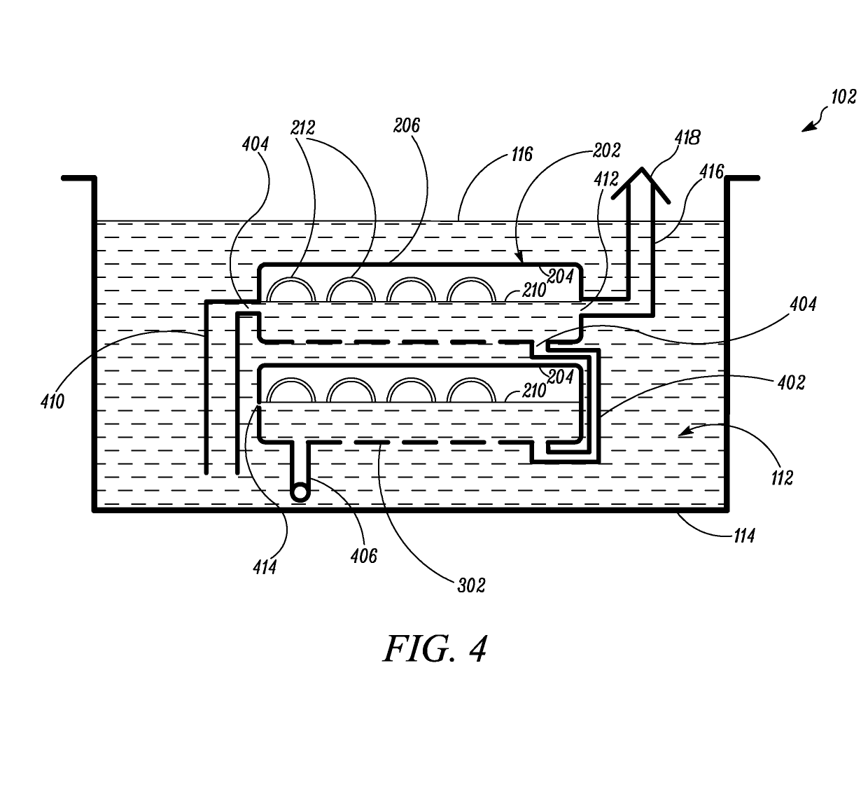

As illustrated in FIG. 4, two trays 202 may be placed in the oil pan 102, according to yet another embodiment of the present disclosure. The trays 202 may be stacked one on top of the other. Moreover, each of the trays 202 may be fluidically connected to each other. The fluidic connection between each of the trays 202 may be formed by one or more channels 402 that form a passage between the screens 302 of the trays 202. The channels 402 may be located at vents 404 provided on the screen 302.

In an embodiment, an oil pump suction 406 may be fluidically connected to the screen 302. Initially the trays 202 are filled with the oil 112. During operation, the oil pump suction 406 may draw the oil 112 through each of the trays 202. Thus, the aeration bubbles 118 may enter in the trays 202 and start to fill the space above ports 412 and 414 with the trapped air. Subsequently, the trapped air in the trays 202 may increase due to the merging of the aeration bubbles 118.

Moreover, a level of the oil 112 in the oil pan 102 measured by any suitable means, such as a dip-stick, may correspondingly rise as well. The rise in the level of the oil 112 in the oil pan may be proportionate to a volume of the trapped air collected within the tray 202. In an embodiment, the level of the oil 112 in the oil pan 102 may rise until a steady state is reached. Any excess air may release to the oil-gaseous interface 116 through the ports 412 and 414. In another embodiment, the ports 412 and 414 may include a channel 416 to transport larger aeration bubbles 214 to an atmosphere above the oil-gaseous interface 116. Further, a cap 418 may be provided on the channel 416 to prevent or reduce any oil droplets falling from engine 100 or baffle plate 110 from entering the channel 416. Moreover, it may be understood to a person skilled in the art that the port 306 (see FIG. 3) may also include the channel 416.

In another embodiment, the tray 202 may be pre-filled with compressed air during initial filling of the oil 112 in the oil pan 102. Moreover, the flow of the oil 112 circulating in the oil pan 102 through the oil pump suction 406 may be kept as slow moving as possible. As described above in connection with FIG. 3, this may facilitate the aeration bubbles 118 to rest on the submerged surfaces 210 for the residence time sufficient for the aeration bubbles 118 to merge.

As illustrated in FIG. 4, the trays 202 thereby progressively facilitate in de-aeration of the oil 112. In an embodiment, the dimensions of the trays 202 may be optimized in order to progressively de-aerate aeration bubbles 118 of increasingly smaller and smaller size. A person of ordinary skill in the art will understand that the arrangement described above may work best when the stack of the trays 202, the vents 404, and channels 402 may be pressure tight and leak proof. However, it may be noted that leaks may cause a minor degradation in the merging of the aeration bubbles 118 at the submerged surface 210; without being detrimental to the overall system performance.

Further, in case the arrangement is leak proof, on stopping the engine 100 the trapped air in the trays 202 may persist until the oil pan 102 is drained. Moreover, dimensions of the tray 202 may be selected in order to provide tilt capability to the oil pan 102 and the tray 202.

In another embodiment, as shown in FIG. 4, a suction pipe 410 may be fluidically connected to the screen 302 of the upper trays 202. The suction pipe 410 may be connected to the vent 404 of the upper tray 202 at one end, and extend towards the bottom surface 114 of the oil pan 102. The suction pipe 410 may draw the oil 112 from the bottom surface 114 of the oil pan 102 thereby providing reliable fluid communication between the tray 202 and the oil 112 even as the level of the oil 112 in the oil pan 102 drops. In yet another embodiment, the suction pipe 410 may be placed in the middle of the oil pan 102 to maximize the tilt capability of the engine 100.

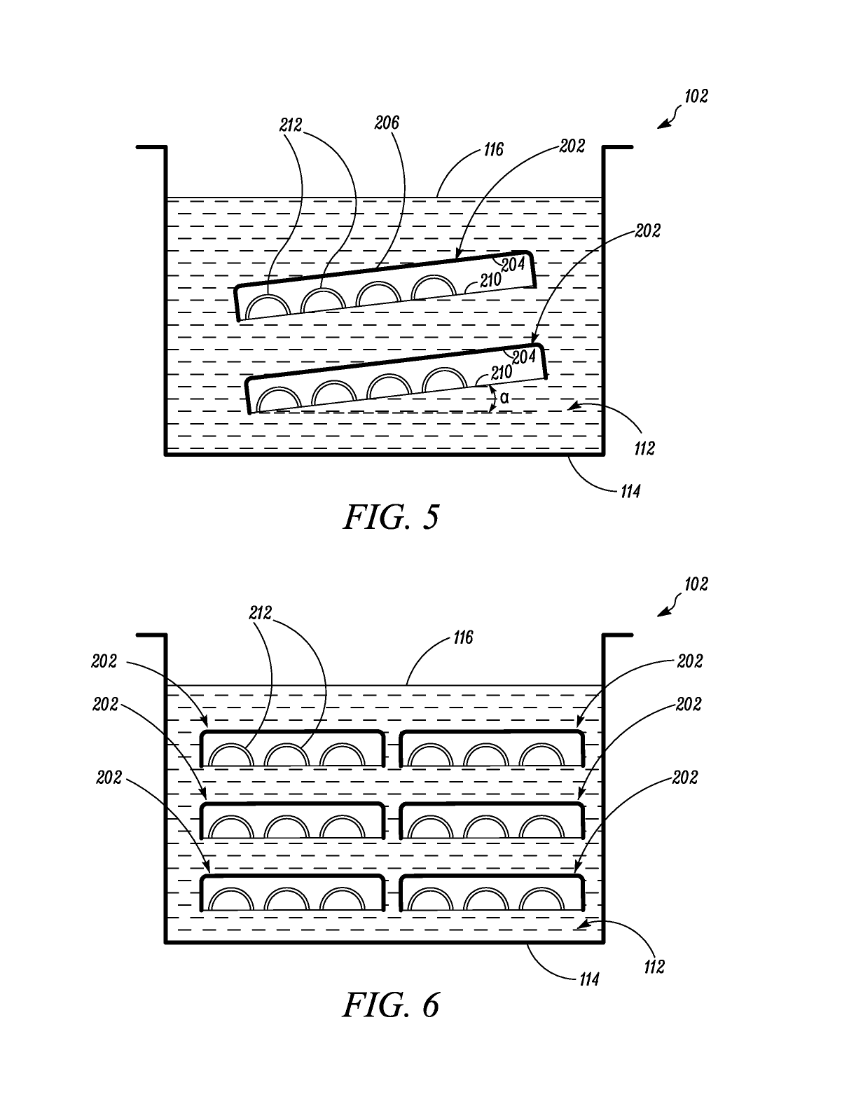

FIGS. 5 and 6 illustrate various arrangements for the plurality of the trays 202 in the oil pan 102. The increase in the number of trays 202 suspended in the oil 112 may correspondingly increase the submerged surface 210 for the aeration bubbles 118 to de-aerate. In an embodiment, the trays 202 may be substantially suspended at an angle α to the bottom surface 114 of the oil pan 102, as shown in the FIG. 5. The angle α may be such that a sine component of a buoyant force F_{b}, including surface texture effects, may facilitate in the movement of the aeration bubbles 118 towards the oil-gaseous interface 116.

FIG. 6 illustrates another plurality of stacks of the trays 202. This arrangement may prevent atmospheric air from stirring the oil-gaseous interface 116. A person of ordinary skill in the art will appreciate that the arrangement may also prevent deep penetration of oil droplets falling from the engine 100, or released from the baffle plate 110 into the oil pan 102. Moreover, the vibrations caused due to operation of the engine 100 may not affect the arrangements described above since the oil 112 present in the oil pan 102 may damp the vibrations.

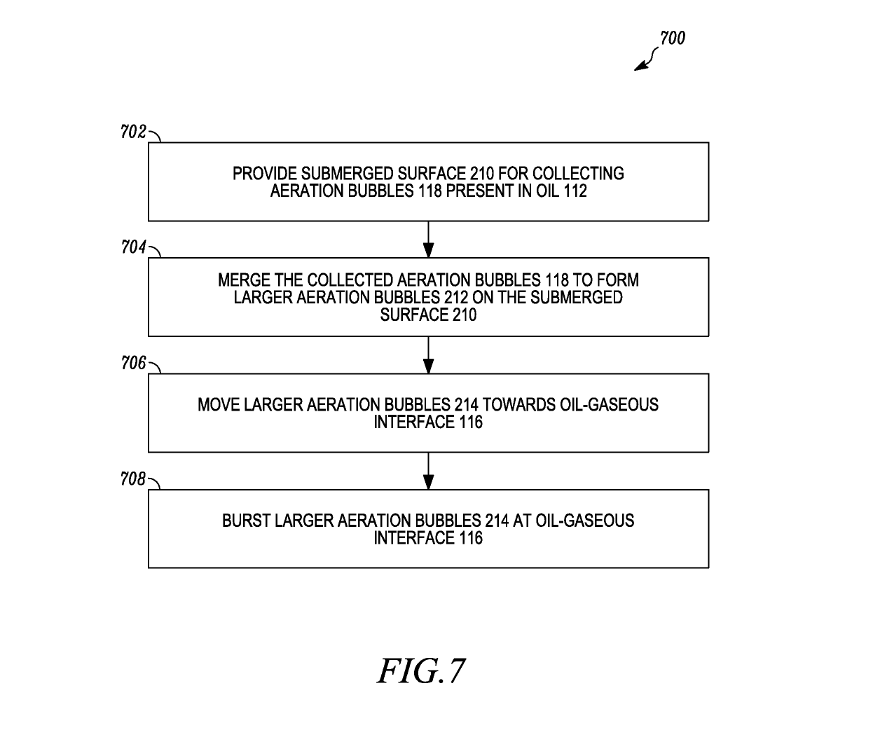

A process 700 for the de-aeration of the oil 112 contained in the oil pan 102 is shown in FIG. 7. At step 702, a submerged surface 210 formed by the tray 202 is provided for collecting the aeration bubbles 118 present in the oil 112.

Further, at step 704, the collected aeration bubbles 118 may merge to form the larger aeration bubbles 212. The larger aeration bubbles 214 may move towards the oil-gaseous interface 116, at step 706. Subsequently, at step 708, the larger aeration bubbles 214 may burst at the oil-gaseous interface 116, to release the trapped air into the atmosphere. The larger aeration bubbles 214 may have a greater buoyant force F_{b} as compared to the aeration bubbles 118, thereby allowing the larger aeration bubbles 214 to move to the oil-gaseous interface 116.

### INDUSTRIAL APPLICABILITY

The increase in the aeration of the oil 112 may cause changes in oil properties leading to a decrease in the life of the oil 112. The aeration of the oil 112 may also cause loss of pumping capacity, loss of viscosity due to entrainment of air, higher wear of running surfaces in bearings, pistons, valve train, and also higher temperatures due to reduced specific heat capacity.

A person of ordinary skill in art will appreciate that when the oil droplets falling from the engine 100 or the baffle plate 110 are impinged on the oil-gaseous interface 116, the aeration bubbles 118 are much harder to separate. It may be noted that even if the aeration bubbles 118 separate towards the surface, the surface tension effects may be much larger than the gravity thinning effects, thereby making it difficult for the aeration bubbles 118 to burst. This may happen because as the aeration bubble 118 size is scaled down, the surface tension effects are retained while the mass of the aeration bubble 118 grows smaller. Moreover, the smaller aeration bubbles 118 may take a long time to burst even after the aeration bubbles 118 reach the oil-gaseous interface 116.

The tray 202 described above provides an effective de-aeration of the oil 112, without increasing the size of the oil pan 102. In the disclosure described herein, by suspending the tray 202 in the oil 112 the submerged surface 210 for the aeration bubbles 118 to merge may be provided. Since the tray 202 is suspended within the oil 112, the distance to be traversed by the aeration bubbles 118 is reduced. The submerged surface 210 may facilitate in forming the larger aeration bubbles 212 by the merging of the aeration bubbles 118. In one embodiment, the larger aeration bubbles 214 may be vented to the atmosphere via the channel 416. The channel 416 provides fluid communication between the tray 202 and the oil-gaseous interface 116.

Generally, the merging of the aeration bubbles 118 to form the larger aeration bubbles 212 and 214 is a very slow process due to insufficient surface area. Moreover, agitation of the oil-gaseous interface 116 may be required in order to destabilize the surface tension, to cause the aeration bubbles 118 to burst.

The larger aeration bubbles 212 and 214 have a greater buoyant force F_{b} as compared to the smaller aeration bubbles 118, making it easier for the larger bubbles 214 to move towards the oil-gaseous interface 116. Further, since the gravitational force of the larger aeration bubbles 212 and 214 is also more, the larger aeration bubble 214 may thin and burst more easily at the oil-gaseous interface 116.

The dimensions of the tray 202 may vary according to the applicability of the tray 202 in different machines. A person of ordinary skill in art will appreciate that although the disclosure has been described in detail with respect to the oil pan 102 used in the engine 100, the disclosure may be used in any machine or machine system which may make use of a lubricating or cooling fluid media for which gaseous aeration may cause a detrimental impact. For example, compressors, turbines, hydraulic rams, hydraulic pistons, internal combustion engines, wind turbines, coolant systems of engines, presses, injection molding, and the like.

Also a person of ordinary skill in the art may adapt the disclosure to the gaseous de-aeration of other gases out of the fluid flow of other liquids. Other gases may include water vapor, exhaust gas, and carbon dioxide, and the like. Other fluids may include water, glycol-water mixes, hydraulic oil, slurries of mud, and the like. Moreover, the disclosure can operate within other fluid reservoirs such as inside pipes, conduits, heat exchangers, batteries, and tanks that are pressurized or otherwise unrelated to the engine 100. One skilled in the art may also adapt the shape of the tray 202 may vary to be other than rectangular such as round, spiral, or helical without departing from the spirit of the disclosure described herein.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A tray for de-aeration of oil contained in an oil pan, the tray comprising:
an inner surface adapted to face a bottom surface of the oil pan;
an outer surface adapted to face an oil-gas interface of the oil contained in the oil pan; and
a side surface extending from the inner surface, the side surface encloses a submerged surface to collect aeration bubbles present in the oil.

2. The tray of claim 1, wherein the tray is suspended substantially parallel to the bottom surface of the oil pan.

3. The tray of claim 1, wherein the tray is suspended substantially at an angle to the bottom surface of the oil pan.

4. The tray of claim 1, wherein the tray further includes a screen disposed adjacent to the tray wherein the screen is in contact with the side surface of the tray.

5. The tray of claim 4, wherein the tray further includes a port provided between the screen and the side surface of the tray.

6. The tray of claim 4, wherein the screen further includes a plurality of apertures such that a diameter of the aperture is greater than or equal to a diameter of the aeration bubbles.

7. The tray of claim 4, wherein the screen is composed of a sheet metal.

8. The tray of claim 4, wherein the tray further includes an oil pump suction fluidically connected to the screen.

9. The tray of claim 1, wherein the tray is composed of a sheet metal.

10. A lubrication system for an engine comprising:
an oil pan having a bottom surface;
oil contained in the oil pan, the oil having a oil-gaseous interface; and
a tray in the oil pan, the tray including:
an inner surface adapted to face a bottom surface of the oil pan;
an outer surface adapted to face an oil-gas interface of the oil contained in the oil pan; and
a side surface extending from the inner surface, the side surface encloses a submerged surface to collect aeration bubbles present in the oil.

11. The lubrication system of claim 10, wherein the tray is suspended substantially parallel to the bottom surface of the oil pan.

12. The lubrication system of claim 10, wherein the tray is suspended substantially at an angle to the bottom surface of the oil pan.

13. The lubrication system of claim 10, wherein the tray further includes a screen disposed adjacent to the tray, the screen is in contact with the side surface of the tray.

14. The lubrication system of claim 13, wherein the tray further includes a port between the screen and the side of the tray.

15. The lubrication system of claim 14, wherein the port includes a channel in communication with an atmosphere above the oil-gaseous interface.

16. The lubrication system of claim 13, wherein the screen further includes a plurality of apertures such that a diameter of the aperture is greater than or equal to a diameter of the aeration bubbles.

17. The lubrication system of claim 13, wherein the lubrication system further includes an oil pump suction fluidically connected to the screen.

18. The lubrication system of claim 10, wherein the lubrication system further includes a plurality of the tray.

19. A method for de-aeration of oil contained in an oil pan, the method comprising:
providing a submerged surface to collect aeration bubbles present in the oil;
merging of the collected aeration bubbles to form larger aeration bubbles on the submerged surface;
moving of the larger aeration bubbles towards an oil-gaseous interface; and
bursting of the larger aeration bubbles at the oil-gaseous interface.

20. The method of claim 20, wherein the bursted larger aeration bubbles are vented above the oil-gaseous interface.
